(19) United States
(12) Patent Application Publication
(10) Pub. No.: US 2016/0097996 A1
(43) Pub. Date: Apr. 7, 2016

(54) FOIL PRINTING

(71) Applicant: HEWLETT-PACKARD INDIGO B.V., Maastricht (NL)

(72) Inventors: Ziv Gilan, Kfar-Harif (IL); Gadi Oron, Rehovot (IL)

(73) Assignee: Hewlett-Packard Indigo, B.V., Fort Collins, CO (US)

(21) Appl. No.: 14/891,097

(22) PCT Filed: May 17, 2013
(86) PCT No.: PCT/EP2013/060256

§ 371 Date: Nov. 13, 2015

(51) Int. Cl. B41F 13/56

(52) U.S. Cl. CPC G03G 15/2007

(57) ABSTRACT

In one example, a foil printer includes a press configured to press together a foil and an image printed on a substrate and an imaging laser configured to selectively direct a laser beam on to the foil or on to the substrate in a pattern of an image to be transferred from the foil to the substrate.

### BACKGROUND

Liquid electro-photographic (LEP) printing uses a special kind of ink to form images on paper or other print substrates. LEP ink includes colored polymer particles dispersed in a carrier liquid. The polymer particles are commonly referred to as toner particles and, accordingly, LEP ink is sometimes called liquid toner. The LEP printing process involves forming an electrostatic pattern of the desired printed image on a photoconductor with an imaging laser and developing the image by applying a thin layer of ink to the charged photoconductor. Charged particles in the ink adhere to the pattern of the desired image on the photoconductor. The liquid ink is transferred from the photoconductor to a heated intermediate transfer member, evaporating much of the carrier liquid to dry the ink to a solid or semi-solid film. The ink film is then pressed on to the cooler print substrate and frozen in place at a nip between the intermediate transfer member and the substrate.

### DRAWINGS

FIG. 1 is a block diagram illustrating one example of a new foil printer.

FIG. 2 is a perspective view illustrating one implementation of the foil printer shown in the block diagram of FIG. 1.

FIGS. 3 and 4 illustrate an LEP printer implementing a foil printer such as the one shown in FIG. 2.

FIGS. 5 and 6 are perspective views illustrating other implementations of the foil printer shown in the block diagram of FIG. 1.

FIG. 7 is a flow diagram illustrating one example of a new foil printing method.

The same part numbers designate the same or similar parts throughout the figures.

### DESCRIPTION

A new foil printing technique has been developed using LEP inks for HP Indigo® printers to help make the process of adding a foil image or texture to an ink image faster and more flexible. Examples of the new technique utilize ink printed on paper or another substrate as the glue to hold the marking material from a marking material foil or as the base to accept a texture from a texturing foil. In one example, an imaging laser selectively heats ink on the substrate in a pattern of the desired foil image to make the ink soft or sticky. The foil is pressed against the heated ink to apply the foil texture or foil image to the printed image on the substrate. A foil printer implementing the new technique may be used, for example, as a post print finishing device in (or with) an LEP printer. It has been shown that activating LEP ink with a laser beam directed on to the back of the foil renders the ink sufficiently tacky to bond the foil to ink on the print substrate in the desired pattern. Examples are not limited to LEP ink or LEP printing, however, but may be implemented with other imaging materials and with other printing devices or as a standalone post-print finishing device.

As used in this document, a “foil” means (1) a thin sheet or web of metal, pigment or other solid marking material, often supplied as a coating on a backing sheet or web (a “marking material foil”), or (2) a thin sheet or web with a textured surface for imprinting the texture on to another surface (a “texturing foil”); “LEP ink” means a polymer in a carrier liquid suitable for electro-photographic printing, with colored pigment particles to print color ink or without pigment particles, for example to print transparent ink; and “imaging laser” means a laser and any associated optic(s) and electronics that can be controlled or configured to scan or otherwise direct a laser beam on to a target in a desired pattern.

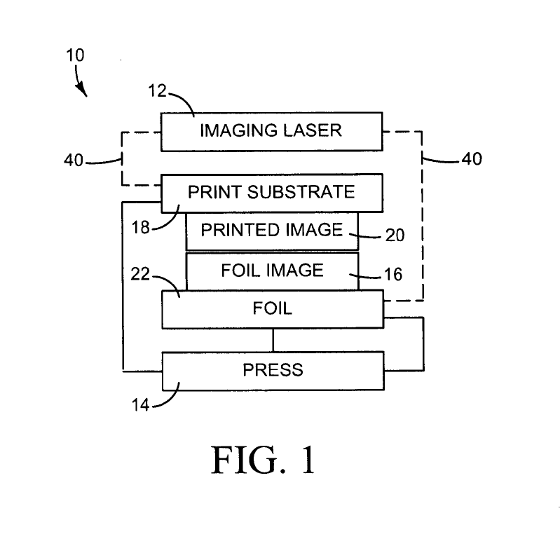

FIG. 1 is a block diagram illustrating one example of a new digital foil printer 10. Referring to FIG. 1, foil printer 10 includes an imaging laser 12 and a press 14 configured together with laser 12 to print a foil image 16 on to a print substrate 18. Laser 12 heats some or all of the LEP ink or other imaging material in an image 20 printed on substrate 18 in the desired pattern for foil image 16. That is to say, the pattern illuminated by laser 12 to heat the imaging material on substrate 18 matches at least part of printed image 20. Press 14 brings image 20 on print substrate 18 into contact with a marking material or texturing foil 22. For a marking material foil 22, the foil sticks to the heated part of image 20 to form foil image 16. For a texturing foil 22, the foil imprints a texture to the heated part of image 20 to form foil image 16. A dual foil 22 that includes both marking material and texturing could also be used, in which case laser 12 is controlled to selective heat the desired parts of image 20 to soft for texture or to sticky for marking material.

In addition to becoming sticky to a marking material foil 22 or impressible to a texturing foil 22 when exposed to laser 12, those parts of image 20 not exposed to laser 12 (if any) must be not sticky or not impressible to foil 22. Testing has shown that LEP inks currently used in HP Indigo® printers are not sticky to a typical metal marking material foil 22 after printing image 20 on substrate 18 and become sticky to a metal marking material foil 22 when reheated to a temperature of 60° C. to 120° C. It is expected that a lower temperature range will be adequate to soften the LEP ink for texturing. Also, it is expected that some of the dry toners currently used in electro-photographic printers (so-called “laser” printers) will work effectively with a foil printer 10 such as that shown in FIG. 1. It might even be possible to use some inkjet inks for use as a foil adhesive.

Imaging laser 12 in the block diagram of FIG. 1 includes a laser and any associated optic(s) and electronics to direct a laser beam 40 on to print substrate 18 or foil 22 in the desired pattern for foil image 16. While it is expected that an imaging laser 12 usually will be used to heat the ink or other imaging material in printed image 20 in the desired pattern, other activating mechanisms may be possible.

The same ink, toner or other imaging material used to print image 20 is used to print foil image 16. Also, the same laser technology and control system used to image the photoconductor in an LEP printer or DEP printer (dry electro-photographic printer) may be readily adapted for use in foil printer 10 rasterizing foil print data; driving the laser according to the print data; and scanning the laser on to the target in the desired pattern with optics that include, for example, a multi-faceted prism, mirrors and lenses. Indeed, the same imaging laser used to form printed image 20 may be used to form foil image 16 for implementations in an LEP or DEP printer. Thus, a foil printer 10 such as that shown in FIG. 1 may be fully digital, foil printing variable data on demand, and it may be operated at printer speeds, printing foil image 16 at the same speed the printer is printing image 20.

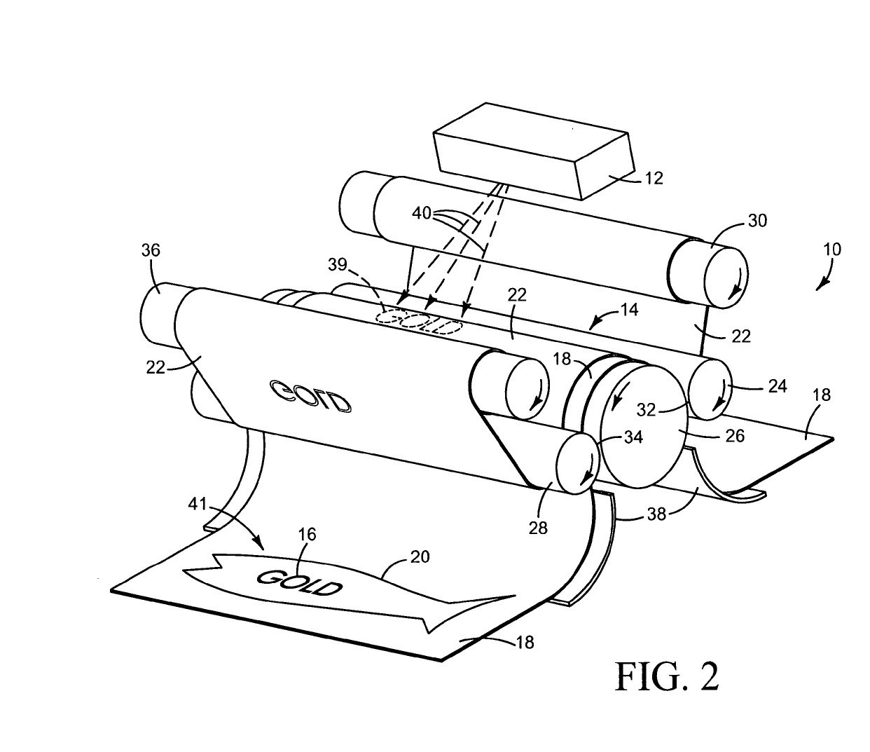

FIG. 2 is a perspective view illustrating one implementation of a foil printer 10 shown in the block diagram of FIG. 1. Referring to FIG. 2, imaging laser 12 is positioned over a press 14 that includes three rollers 24, 26, and 28. A marking material foil 22 is dispensed from a supply roller 30, through a first nip 32 between first and second rollers 24, 26, over second roller 26 to a second nip 34 between second and third rollers 26, 28, to a take-up roller 36. Print substrate 18 moves along guides 38 through first nip 32, over second roller 26, and through second nip 34. Foil 22 and substrate 18 are brought together at first nip 32, pulled taut over second roller 26 to maintain contact, and then compressed further at second nip 34. In operation, laser 12 illuminates the back of foil 22 with a laser beam 40 in the pattern 39 of foil image 16—the letters “GOLD” in the example shown. The laser beam 40 heats imaging material 20 on substrate 18 through foil 22, which is stretched over second roller 26 in contact with substrate 18. Foil 22 is pressed against imaging material 20 at second nip 34 to help ensure a robust bond between foil 22 and the heated, sticky imaging material 20, to form the composite ink and foil image 41—a “GOLD” fish in this example.

A marking material foil 22 usually is supplied as a thin metal, pigment or other coating on a backing web or sheet. A marking material foil web 22 is shown in FIG. 2. The marking material coating sticks to the heated part of image 20 and peels from the backing as foil 22 and substrate 18 separate downstream of nip 34. For an LEP ink image 20, testing indicates that a robust bond is formed between foil 22 and ink 20 at temperatures in the range of 60° C. to 120° C., and that the desired temperature may be reached, for example, by exposing the back of a foil 22 moving at 0.5 m/s-0.6 m/s to a laser beam in the infrared range of wavelengths from a 600 W-1600 W laser with a spot area not more than 1 square millimeter.

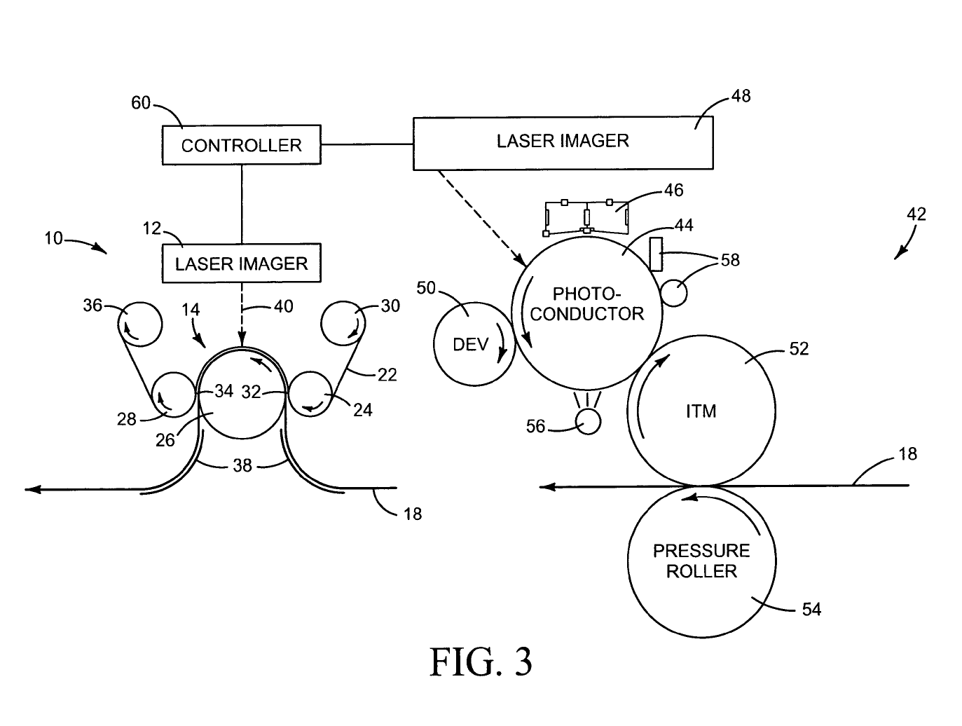

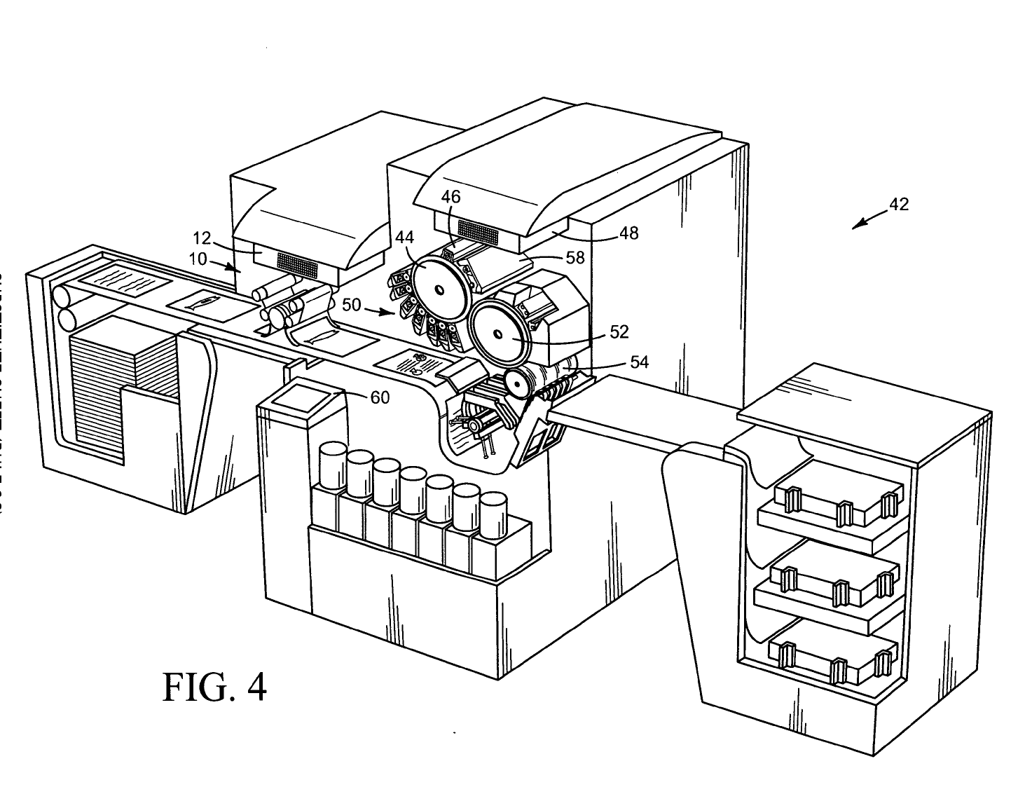

FIGS. 3 and 4 illustrate an LEP printer 42 implementing a foil printer 10 such as the one shown in FIG. 2. Although foil printer 10 may be implemented as a stand-alone finishing device remote from printer 42, a foil printer 10 implemented in (or close to) printer 42 will receive a print substrate 18 and ink image 20 that is still warm from the LEP printing process. Thus, less energy is needed to heat the ink for foil printing than if the ink had cooled to room temperature.

Referring to FIGS. 3 and 4, in an LEP printer 42 a uniform electrostatic charge is applied to a photoconductive surface, the outer surface of a photoconductor drum 44 for example, by a scorotron or other suitable charging device 46. A laser imager or other suitable photo imaging device 48 exposes selected areas on photoconductor 44 to light in the pattern of the desired image 20 (FIG. 2). A thin layer of ink is applied to the patterned photoconductor 44 using a developer 50. Developer 50 represents generally a typically complex unit that supplies different color inks to a series of small rollers that rotate against photoconductor 44. The latent image on photoconductor 44 is developed through the application of ink which adheres to the charge pattern on photoconductor 44, developing the latent electrostatic image into an ink image.

The liquid ink image is transferred from photoconductor 44 to a heated intermediate transfer member (ITM) 52, evaporating much of the carrier liquid to dry the ink to a solid or semisolid film. The ink film is then pressed on to a cooler print substrate 18 and frozen in place at the nip between intermediate transfer member 52 and a pressure roller 54. A lamp or other suitable discharging device 56 removes residual charge from photoconductor 44 and ink residue is removed at a cleaning station 58 in preparation for developing the next image or for applying the next color ink layer.

Printer 42 also includes a controller 60. Controller 60 in FIGS. 3 and 4 represents generally the programming, processors and associated memories, and the electronic circuitry and components needed to control the operative elements of a printer 42. Controller 60 usually will receive printing instructions as vector data, rasterize the vector data, and drive imaging lasers 12, 48 and other printer components according to rasterized printing data. Although controller 60 is shown as a discrete component in FIGS. 3 and 4, elements of controller 60 may reside on other components of printer 42. For example, each imaging laser 12, 48 may include a microprocessor or microcontroller that performs some or all of the laser control functions.

For color printing, each color ink is usually patterned and developed individually on photoconductor 44 and transferred to intermediate transfer member 52 and substrate 18 as individual layers. Any single layer of LEP ink may be used as the adhesive to form foil image 16 or multiple layers of individual colors may be combined to form the adhesive for foil image 16. The pattern of image 20 applied to photoconductor 44 covers the pattern for foil image 16 as well as the pattern for a printed ink image, if any. In one example, the pattern applied to photoconductor 44 includes the exact pattern for foil image 16. In another example, the pattern applied to photoconductor 44 includes a pattern covering more than the exact the pattern for foil image 16. A covering pattern for foil image 16 may coat the entire print substrate with one color ink (e.g., white ink) for one example, or with transparent ink for another example, or a covering pattern may include the pattern for foil image 16 within the pattern for the printed ink image. Other suitable configurations for a covering pattern are possible. In any case, because one or more ink layers are used as glue for the foil image, at least one ink layer must be present at any location where the foil is to be printed.

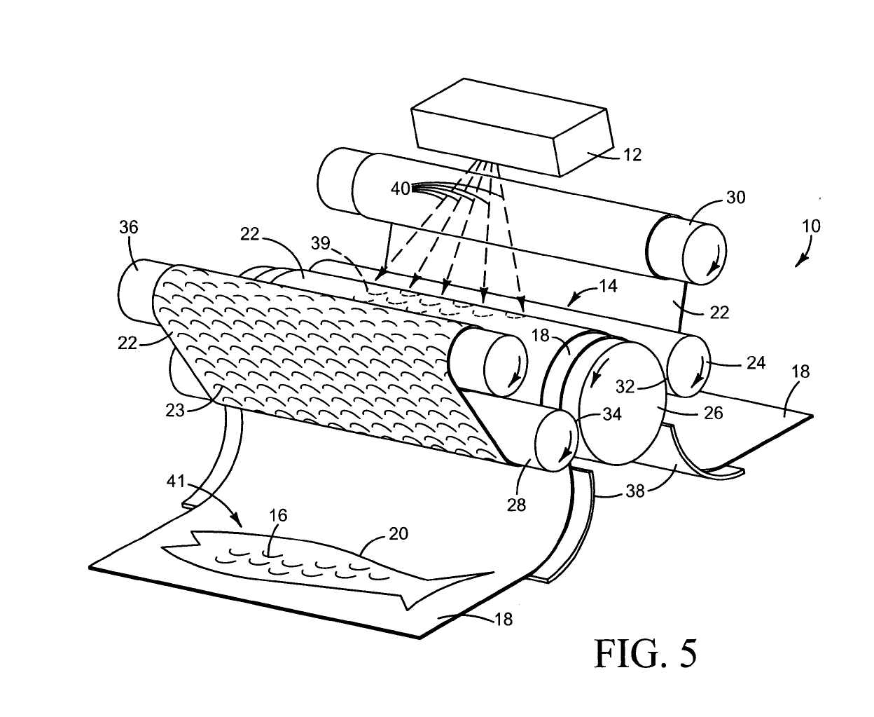

FIG. 5 is a perspective view illustrating another implementation of a foil printer 10 shown in the block diagram of FIG. 1. In this implementation, a texturing foil 22 is dispensed from supply roller 30, through nips 32, 34 and over second roller 26. Foil 22 includes a textured surface 23 that functions as a die to imprint the texture on the LEP ink or other printed imaging material. In operation, laser 12 illuminates the back of foil 22 with a laser beam 40 in the pattern 39 of foil image 16—a group of fish scales in the example shown—to heat imaging material 20 until it is soft enough to receive an imprint from foil 22. The textured surface 23 of foil 22 is pressed against imaging material 20 at second nip 34 to imprint the texture to the impressible part of imaging material 20 heated by laser 12, to form a composite image 41 that includes textured scales in foil image 16 within a fish outline of un-textured imaging material 20. A specific pattern may be used on surface 23 to match laser pattern 39, such as the fish scale pattern shown in FIG. 5, or a generic texture may be used on surface 23.

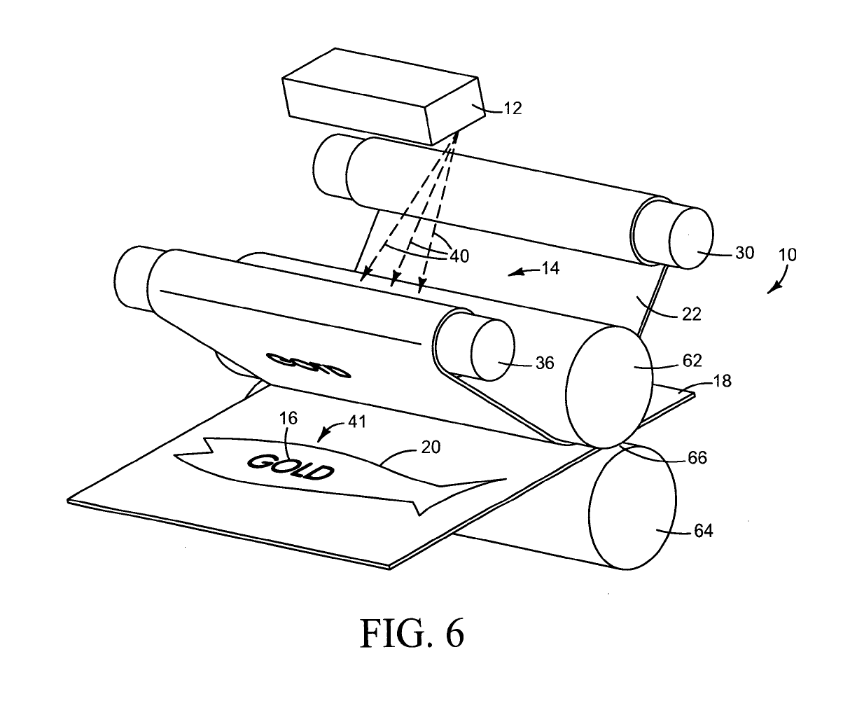

FIG. 6 is a perspective view illustrating another implementation of a foil printer 10 shown in the block diagram of FIG. 1. In this implementation, and referring to FIG. 6, press 14 includes two rollers 62 and 64. A marking material foil 22 is dispensed from supply roller 30, through a nip 66 between first and second rollers 62, 64 to take-up roller 36. Print substrate 18 moves straight through nip 66 where it is pressed together with foil 22. In operation, laser 12 illuminates the back of foil 22 through first roller 62 with laser beam 40 in the pattern of foil image 16. Laser beam 40 heats imaging material 20 on substrate 18 through foil 22 at nip 66. In this implementation, first roller 62 is transparent to the wavelength of laser beam 40 and the imaging material is heated simultaneously with compressing substrate 18 and foil 22 at nip 66.

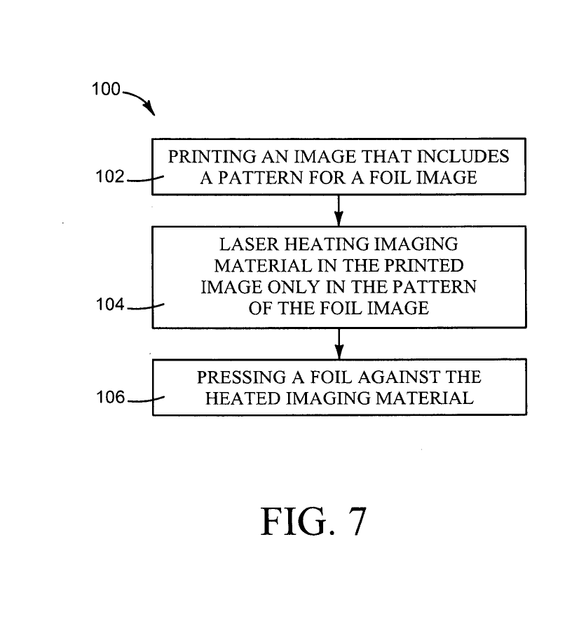

FIG. 7 is a flow diagram illustrating one example of a new foil printing method 100. Referring to FIG. 7, foil printing method 100 includes printing an image that includes a pattern for a foil image (block 102), laser heating imaging material in the printed image, only in the pattern of the foil image, until the heated imaging material is sticky for a marking material foil or impressible for a texturing foil (block 104), and pressing the foil against the heated imaging material (block 106). In one specific implementation, described above, the imaging material is an LEP ink, the printing includes forming a solid or semisolid layer of LEP ink on a substrate, the foil is a marking material foil, and the laser heating includes laser heating the layer of LEP ink in the pattern of the foil image to 60° C. to 120° C.

The examples shown in the figures and described above illustrate but do not limit the claimed subject matter. Other examples may be made and implemented. The foregoing description, therefore, should not be construed to limit the scope of the claimed subject matter.

1. A foil printer, comprising:
a press configured to press together a foil and an image printed on a substrate; and
an imaging laser configured to selectively direct a laser beam on to the foil or on to the substrate in a pattern of an image to be transferred from the foil to the substrate.

2. The foil printer of claim 1, wherein the imaging laser is further configured to direct the laser beam on to the foil or on to the substrate to cause an imaging material in the image printed on the substrate sticky to a marking material on the foil.

3. The foil printer of claim 1, wherein the imaging laser is further configured to direct the laser beam on to the foil or on to the substrate to cause an imaging material in the image printed on the substrate impressible to a texture on the foil.

4. The foil printer of claim 1.

5. The foil printer of claim 1, further comprising a foil dispenser configured to dispense the foil as a foil web to the press.

6. The foil printer of claim 1.

7. The foil printer of claim 1, wherein the press comprises a nip between two rollers.

8. The foil printer of claim 7, wherein:
the nip between two rollers comprises a first nip between a first roller and a second roller and a second nip between the second roller and a third roller, the first nip located upstream from the second nip in the direction the substrate and the foil move together through the press, and the first nip and the second nip located with respect to one another such that the substrate and the foil moving together through the press from the first nip to the second nip are pulled taut over the second roller; and
the imaging laser is positioned to direct a laser beam on to that part of the foil pulled taut over the second roller or on to that part of the substrate pulled taut over the second roller.

9. A printer, comprising:
a first printing device configured to print a solid or semisolid ink or toner image on a substrate; and
a second printing device operatively coupled to the first printing device to receive a printed substrate, the second printing device configured to:
heat ink or toner printed on the printed substrate in a pattern of a foil image to be transferred from a foil to the printed substrate; and
press the foil against the heated part of the image printed on the substrate.

10. The printer of claim 9, wherein the second printing device comprises:
a press to press together the foil and the heated part of the image printed on the substrate; and
an imaging laser configured to direct a laser beam on to the foil or on to the substrate in the pattern of the foil image to make heated part of the image printed on the substrate sticky to the foil.

11. The printer of claim 9, wherein the first printing device is configured to print a solid or semisolid ink image on the substrate with liquid electro-photographic ink and the second printing device is configured to heat the liquid electro-photographic ink printed on the substrate to 60° C. to 120° C. in the pattern of the foil image to be transferred from the foil to the substrate.

12. A foil printing method, comprising:
printing an image that includes a pattern for a foil image;
laser heating imaging material in the printed image only in the pattern of the foil image; and
pressing a foil against the heated imaging material.

13. The foil printing method of claim 12, wherein:
the laser heating comprises laser heating imaging material in the printed image only in the pattern of the foil image until the heated imaging material is sticky to a marking material on the foil; and
the pressing comprises pressing the marking material foil against the sticky imaging material.

14. The foil printing method of claim 13, wherein:
the imaging material is liquid electro-photographic ink;
the printing comprises forming a solid or semisolid layer of the liquid electro-photographic ink on a substrate; and
the laser heating comprises laser heating the layer of the liquid electro-photographic ink only in the pattern of the foil image to 60° C. to 120° C.

15. The foil printing method of claim 12, wherein:
the laser heating comprises laser heating imaging material in the printed image only in the pattern of the foil image until the heated imaging material is impressible to a texture on the foil; and
the pressing comprises pressing a texturing foil against the impressible imaging material.
